(19) United States
(12) Patent Application Publication
(10) Pub. No.: US 2020/0106790 A1
(43) Pub. Date: Apr. 2, 2020

(54) INTELLIGENT SYSTEM FOR MITIGATING CYBERSECURITY RISK BY ANALYZING DOMAIN NAME SYSTEM TRAFFIC

(71) Applicant: FireEye, Inc., Milpitas, CA (US)

(72) Inventors: Ken BAGNALL, County Kildare (IE); Ralph CASEY, Leopardstown Dublin 18 (IE); John JENSEN, Nova Scotia (CA)

(21) Appl. No.: 16/146,211

(22) Filed: Sep. 28, 2018

(51) Int. Cl. H04L 29/06; H04L 12/26; H04L 29/12; G06F 17/30

(52) U.S. Cl. CPC H04L 63/1425; H04L 63/1416; H04L 63/1441; G06F 17/30345; H04L 43/08; H04L 61/1511; H04L 63/1433

(57) ABSTRACT

A system, method and computer-readable medium for mitigating cybersecurity risk by analyzing domain name system (DNS) traffic, including detecting a network communication propagated over a computer network, the network communication comprising a domain identifier, monitoring DNS traffic to and from one or more DNS servers relating to the domain identifier, the DNS traffic including one or more DNS queries and one or more corresponding responses, extracting information from the monitored DNS traffic to generate a record identifier, updating a DNS metadata record stored in memory and associated with the record identifier based at least in part on the monitored DNS traffic, the DNS metadata record including one or more occurrence metrics associated with instances of the domain identifier in previous DNS traffic, determining whether the one or more occurrence metrics are indicative of a cybersecurity risk, and activating one or more mitigation actions based at least in part on a determination that the one or more occurrence metrics are indicative of the cybersecurity risk.

### BACKGROUND

The problem of cyber-attacks in enterprise networks is a pervasive and highly publicized topic. Common vectors of attack on enterprise networks include email-based attacks (e.g., phishing attacks, etc.), web content (e.g., automated scripts), and file-based attacks, etc. Cyber-attacks may exploit known or unknown security vulnerabilities including software, system, and human vulnerabilities. In some situations, an attack may be perpetrated by malware, which is a program, file, or digital data object e.g., through a malicious object embedded within content and designed to adversely influence (i.e., attack) normal operations of a computer. Examples of different types of malware include bots, computer viruses, worms, Trojan horses, spyware, adware, or any other programming that operates within the computer without permission.

In other situations, persons looking to infiltrate a network or steal sensitive data have utilized a method known as phishing. A phishing attack comprises the transmission of an electronic communication, such as an email, to a targeted recipient or a broad group of recipients. A phishing email purports to be from a known institution, such as a bank or credit card company, and appears to have a legitimate purpose. The communication can mimic the appearance of a legitimate email from the known institution, such as, by including logos, trade names, or other identifiers that lead the recipient to believe the email is authentic. Embedded in the phishing email is a Uniform Resource Locator (URL) that directs the recipient to a website requesting the recipient to enter credential information, such as for the purpose of changing their password. The phishing attack is completed when the recipient of the email enters (i.e. submits) credential information to the website, which is then delivered to the author of the phishing attempt, who may then use stolen credentials to obtain unauthorized access to recipient(s) accounts or other resources.

While email is an important and necessary means of communication in business, it is inherently insecure for a variety of reasons. Many email systems have no built-in mechanism for verifying that an email was sent from the sender it claims to be sent from. Furthermore, human error (i.e. user error) is a major threat to a company's information technology (IT) infrastructure as it often opens or represents a security vulnerability in the infrastructure. These vulnerabilities subject enterprise networks to the possibility of a cyber-attack through malware and phishing attacks. Consequently, malware can infect endpoints, deleting and/or extracting information, hold user information hostage (through encryption), and damage network connected resources. To protect the network computer resources of enterprises, cybersecurity vendors, such as FireEye, Inc., develop email-based cybersecurity products and services.

The Domain Name System (DNS) is a hierarchical decentralized naming system for any hardware or software resources connected to a network, such as the Internet. DNS associates various items of information, such as Internet Protocol (IP) addresses, with domain names assigned to each of the participating entities.

In cybersecurity, passive DNS systems can be used to identify cyberattacks. Passive DNS systems connect to a plurality of recursive name servers (rNS), request DNS information, such as IP addresses, associated with domains identified by the rNS, and store this DNS information in individualized entries of a log. Based on the DNS information collected by the passive DNS system, a security researcher can, for example, identify relationships between the DNS information of different log entries by studying and mining the data.

Unfortunately, there are several drawbacks with the passive DNS approach for cybersecurity monitoring. Since passive DNS monitoring typically stores DNS records as individual data records and typical network traffic can result in thousands of DNS queries per day, the physical resources (in terms of hardware and software) required to store and maintain this data for any useful period of time are significant. Additionally, because the data is stored in individual data entries, analysts cannot easily deduce relationships between the various entries that may correspond to similar DNS information.

More significantly, the current approach of passive DNS monitoring is a highly interactive, manual, and time-consuming process that is completely unsuited to dynamic risk monitoring and mitigation. For example, a passive DNS system encountering a new domain name or new DNS information pertaining to a domain name would not be able to analyze the DNS information and determine and implement a timely mitigation.

Accordingly, improvements are needed in DNS systems for cyber-attack detection, prevention, and mitigation in a computer network.

### BRIEF SUMMARY OF THE INVENTION

Applicant has discovered a novel, automated, method, apparatus, and computer-readable medium for mitigating cybersecurity risk by analyzing domain name system (DNS) traffic. The intelligent system disclosed herein utilizes aggregate DNS traffic information, including occurrence metrics, corresponding to a particular domain identifier in a detected network communication to make real-time assessments of cybersecurity risks posed by the network communication and to implement real-time mitigation actions when a cybersecurity risk is detected.

The system accomplishes this real-time assessment and mitigation by continuously updating DNS metadata records corresponding to detected domain identifiers within network communications with aggregate information based upon monitored DNS traffic relating to the detected domain identifiers. The aggregate information includes occurrence metrics generated based upon DNS traffic relating to previous instances of the domain identifiers detected in previous network communications.

The aggregate information corresponding to a detected domain identifier is then utilized to assess cybersecurity risks posed by a detected network communication containing the detected domain identifier and to implement appropriate mitigation actions if the cybersecurity risk exceeds certain cybersecurity risk thresholds.

The aggregate information corresponding to detected domain identifiers is stored in DNS metadata records that are accessed using record identifiers that are generated from the monitored DNS traffic corresponding to the detected domain identifiers. This storage structure makes it possible for the system to utilize monitored DNS traffic to accurately and quickly perform lookup operations for aggregate information corresponding to a particular detected domain identifier, while at the same time updating the relevant DNS metadata records with newly detected DNS traffic. The monitored DNS traffic serves the dual purpose of providing the data which is used to update aggregate information in the DNS metadata record and also providing the data which is used to query the DNS information database for the relevant DNS metadata records.

The intelligent system disclosed herein therefore provides the novel solution of utilizing aggregate DNS traffic information (i.e., aggregate information derived from previous DNS queries and responses to and from name servers) relating to a particular domain identifier to make an assessment of cybersecurity risk for detected network communications (i.e., any communications involving a monitored device or component) that contain that domain identifier.

The intelligent system for mitigating cybersecurity risk by analyzing DNS traffic disclosed herein improves upon passive DNS monitoring systems. Unlike passive systems that can only be used manually by security analysts, the present system provides an action platform that continually ingests DNS traffic to maintain aggregate information relating to domain identifiers and then utilizes that aggregate information in real-time to detect and mitigate cybersecurity risks stemming from network communications containing domain identifiers. The present system can therefore be utilized for timely detection and mitigation of cybersecurity attacks from a variety of cybersecurity attack vectors in real-time, including email messages, web content, or any other type of network communication.

### BRIEF DESCRIPTION OF THE DRAWINGS

FIG. 1 illustrates the system for mitigating cybersecurity risk by analyzing domain name system (DNS) traffic and components that communicate with the system according to an exemplary embodiment

FIG. 2 illustrates an example of a table 200 in the DNS database according to an exemplary embodiment.

FIG. 3 illustrates a message flow diagram between components of the system for mitigating cybersecurity risk by analyzing domain name system (DNS) traffic according to an exemplary embodiment.

FIG. 4 illustrates a flowchart for cybersecurity risk assessment and mitigation according to an exemplary embodiment.

FIG. 5 illustrates an exemplary computing environment that can be used to carry out methods for mitigating cybersecurity risk by analyzing domain name system (DNS) traffic.

### DETAILED DESCRIPTION

While methods, apparatuses, and computer-readable media are described herein by way of examples and embodiments, those skilled in the art recognize that methods, apparatuses, and computer-readable media for mitigating cybersecurity risk by analyzing domain name system (DNS) traffic are not limited to the embodiments or drawings described. It should be understood that the drawings and description are not intended to be limited to the particular forms disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “can” is used in a permissive sense (i.e., meaning having the potential to) rather than the mandatory sense (i.e., meaning must). Similarly, the words “include,” “including,” “includes”, “comprise,” “comprises,” and “comprising” mean including, but not limited to.

As discussed above, improvements are needed in DNS monitoring systems for cyber-attack detection, prevention, and mitigation in a computer network. Applicant has discovered novel methods, apparatuses, and computer-readable media for utilizing monitored DNS traffic relating to previously detected domains to assess the cybersecurity risk from new network communications that contain those domains. Applicant has additionally developed a novel DNS traffic aggregation and storage structure that tracks occurrence metrics relating to DNS traffic associated with identified domains and enables a cyberattack detector unit (or module) to both update the relevant occurrence metrics for new network communications and utilize the existing occurrence metrics to assess cybersecurity risk for the new network communications.

The disclosed methods, apparatuses, and computer-readable media not only reduce the overhead (in terms of hardware and software resources) required to store meaningful DNS data, they also enable significantly faster computation of risk profiles of network communications. Unlike previous passive DNS systems that store records corresponding to each occurrence of DNS traffic, uncoupled from any structure that allows for aggregation, the present system utilizes a DNS metadata record that stores aggregate metrics corresponding to previous DNS traffic associated with a particular domain. This aggregate data is then queried in real-time as new network communications associated with that domain are detected to retrieve occurrence metrics used to assess cybersecurity risk. This real-time retrieval of aggregated occurrence metrics, in turn, enables automated and dynamic risk mitigation strategies at the time of receipt of a network communication, and not in hindsight, by an analyst, after a cyber-attack has already occurred.

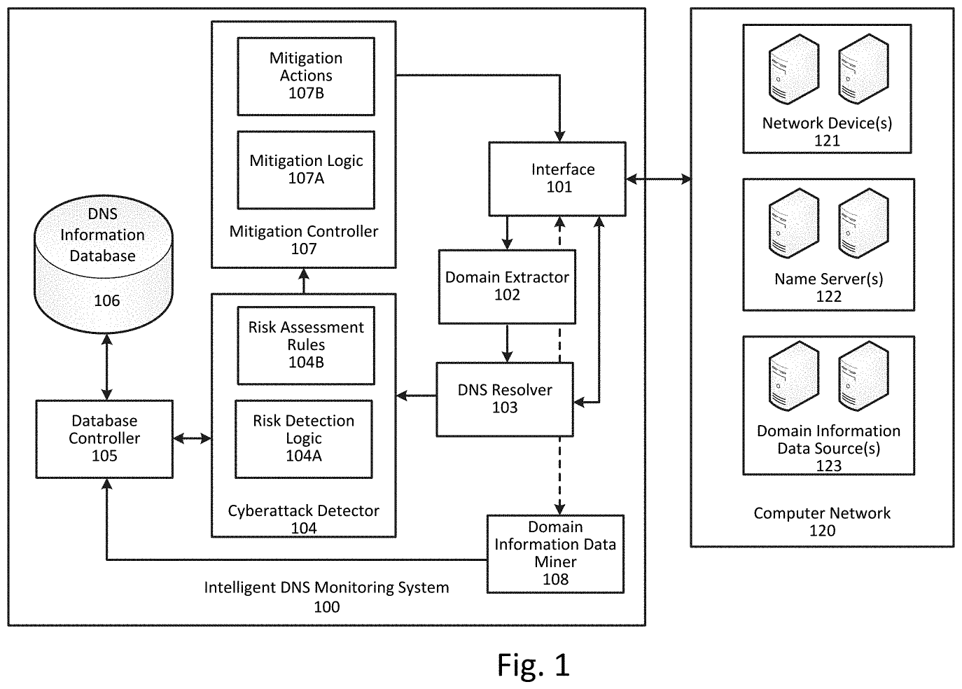

FIG. 1 illustrates an intelligent DNS monitoring system 100 for mitigating cybersecurity risk by analyzing domain name system (DNS) traffic according to an exemplary embodiment.

Intelligent DNS Monitoring System 100 includes an interface 101 that configured to monitor network traffic in a computer network 120. Interface 101 is a network interface that detects network communications to and from devices within the computer network 120, such as network communications sent between network devices 121. Network communications include, for example, Simple Mail Transfer Protocol (SMTP) handshake requests transmitted between network devices 121, SMTP email messages transmitted between network devices 121, and/or a web browser requests transmitted between network devices 121. The interface 101 can be configured to monitor to one or more types of network communications (e.g., SMTP messages) and to detect any new network communications that fall within one of the monitored types of network communications.

Interface 101 additionally sends and receives information to and from components of the intelligent DNS monitoring system 100 and devices on the computer network 120, including name servers 122 storing DNS information and domain information data sources 123 storing information associated with various domains. In this way, interface 101 serves as the intermediary routing mechanism for messages and data exchanged between the intelligent DNS monitoring system 100 and devices on the computer network 120.

Intelligent DNS Monitoring System 100 includes a domain extractor 102 configured to extract domain identifiers from monitored network communications. Domain extractor 102 receives monitored network communications from interface 101 and includes a parser for parsing the text of the monitored network communications (or a copy of the monitored network communications) and an extractor for identifying and extracting domain identifiers from the monitored network communications. Multiple parsers and extractors can be used for different types of communications. For example, an SMTP parser can interpret SMTP commands and values within an SMTP message and identify a domain identifier within an SMTP messages based upon the interpreted text. Similarly, a transmission control protocol/internet protocol (TCP/IP) parser can interpret TCP/IP messages and extract domain identifiers from those messages. The parsed domain identifier can be in a header of the network communication, in a particular command or message (such as an SMTP command or TCP/IP message) or in the body of the network communication (such within a Uniform Resource Locator (URL) with an email body).

Intelligent DNS Monitoring System 100 further includes a DNS resolver 103 that is configured to receive the extracted domain identifier from the domain extractor 102 and transmit one or more DNS queries, via interface 101, to one or more name servers 122 in computer network 120. The DNS queries include the received domain identifier and a requested DNS record type, such as an address mapping A record, an AAAA record, a Canonical Name (CNAME) record, a Mail Exchange (MX) record, a text (TXT) record, a Name Server (NS) record, or a host information (HINFO) information record.

The one or more name servers 122 resolve the DNS queries and return, via the interface 101, one or more responses corresponding to the one or more DNS queries to the DNS resolver 103. The response returned to the DNS resolver includes a DNS response value corresponding to the DNS record type which is being requested. For example, a request for MX records will return a DNS response value that is a mail server address. After receipt of the one or more responses, the monitored DNS traffic information, including the DNS queries and the corresponding responses, are then provided to the cyberattack detector 104, along with the relevant domain identifiers.

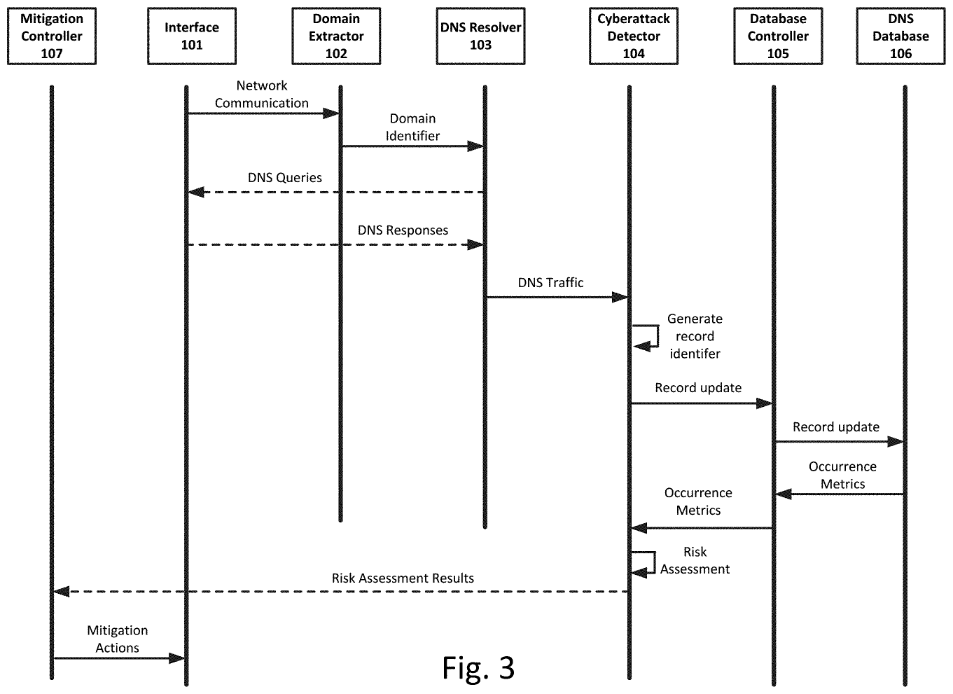

Cyberattack detector 104 includes a risk detection logic 104A component that is configured to extract information from the monitored DNS traffic to generate a record identifier. The process for extraction of information and generation of the record identifier is explained in greater detail with respect to FIG. 3, but generally involves the creation of a record identifier based on at least the domain identifier and optionally also a DNS record type and/or DNS response value in the monitored DNS traffic.

Cyberattack detector 104 then updates a DNS metadata record associated with the record identifier that is stored in a memory of the intelligent DNS monitoring system 100. The DNS metadata record can be stored in any type of data structure, such as a relational or structured database, a semi-structured database, or an unstructured database (such as a NoSQL database). The DNS metadata record can also be stored in any type of underlying file system. For example, the file system can be a disk based file system such as a File Allocation Table (FAT) file system or a flash file system built upon flash memory.

In the embodiment shown in FIG. 1, the DNS metadata records are stored in a DNS information database 106 which can be a structured relational database (such as a structured query language database) or an unstructured database. The update request from the cyberattack detector 104 is routed through the database controller 105 to the DNS information database 106, where it is then applied to update the DNS metadata record corresponding to the record identifier.

The update request itself can include the record identifier in order to enable the database controller 105 and/or DNS information database 106 to locate the appropriate DNS metadata record for updating. Additionally, the update request can be an “upsert” request—i.e., a request to update existing records or insert new records where no prior record exists.

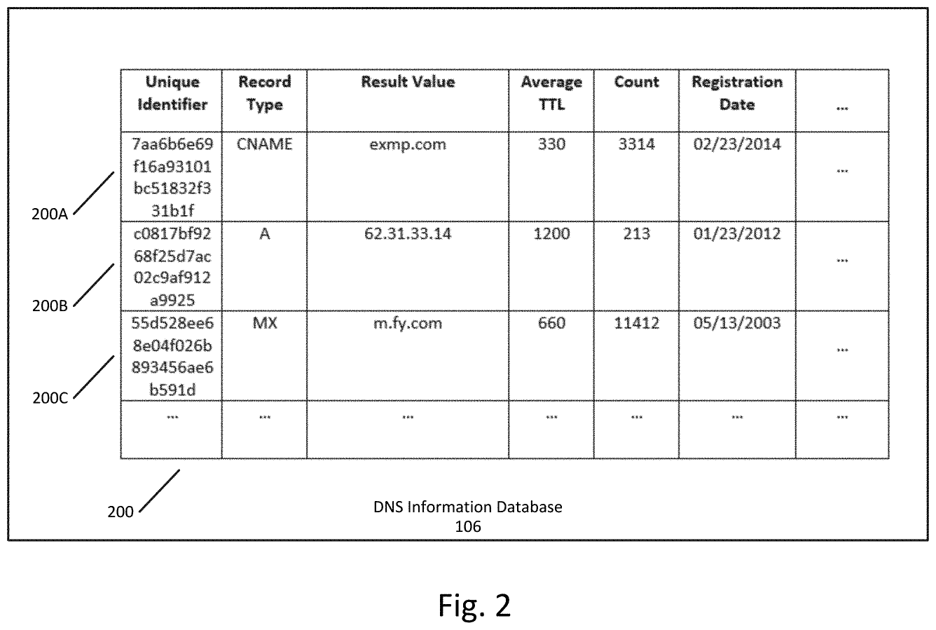

Examples of DNS metadata records are illustrated in FIG. 2, which shows an example of a table that can be stored in the DNS Information Database. As shown in FIG. 2, table 200 includes DNS metadata records 200A, 200B, and 200C, corresponding to columns of the table 200. Each of the DNS metadata records includes a record identifier that is generated based at least in part on a domain identifier, as well as one or more occurrence metrics associated with instances of the domain identifier in previous DNS traffic. For example, DNS metadata records 200A-200C include the occurrence metrics of average time-to-live (TTL) values of DNS responses previously received relating to the domain identifier, a count of previous DNS queries transmitted relating to the domain identifier, and a date of registration of a particular domain corresponding to each record identifier. A TTL value is a duration (usually in seconds) associated with a value returned in response to a DNS query that indicates the lifespan of the particular resource specified by the response. The TTL value indicates how long the particular resource will be valid.

Of course, these occurrence metrics are provided for illustration only and other types of occurrence metrics can be utilized. For example, the average TTL value can be a moving average tied to a user-configurable or predefined time period, such as a 50-day average TTL value or a 100-day average TTL value. In this case, time stamps associated with updates to records can also be stored in the database to determine whether previous TTL values are factored into the average. TTL values can also be aggregated in other ways, such as a time-weighted average, where more recent TTL values are given a higher weighting than older TTL values. This can allow for the determination of an average TTL value that reflects trends in the responses provided to DNS queries, thereby providing a more current baseline from which to identify deviations from the trends. Other examples of occurrence metrics that can be stored in the DNS metadata records include an initial date of detection that records the date when DNS traffic pertaining to a particular domain was monitored, a date range corresponding to each record identifier that indicates a date range associated with the corresponding DNS traffic, a quantity of prior updates to the DNS metadata record, an occurrence rate of updates to the DNS metadata record during a time period, and/or an inactivity period corresponding to each record identifier that tracks time period since corresponding DNS traffic was detected. Occurrence metrics that rely on time periods can be determined based on timestamps associated with each occurrence of a particular domain identifier stored in the DNS information database.

These examples are not intended to be limiting, and the occurrence metrics stored for each DNS metadata record can be customized and configured by end-users, such as system administrators.

Occurrence metrics are updated continuously, periodically, or on-the-fly as new DNS traffic pertaining to a particular domain identifier is monitored. For example, if newly monitored DNS traffic corresponding to a particular record included a new TTL value, then the update can include multiplying the existing average TTL value by the existing count to generate a total TTL product, adding the new TTL value to the total TTL product, and dividing the sum by the existing count plus one. As shown in FIG. 2, each DNS metadata record including each of the occurrence metrics can correspond to a type of DNS record. Therefore, each occurrence metric is updated based on DNS traffic associated with the corresponding type of DNS record.

Each DNS metadata record can include additional fields related to the DNS traffic corresponding to a domain identifier or the network communication that contains the domain identifier. For example, DNS metadata records 200A-200C include a record type field and/or a DNS response value field. Other DNS traffic information that can be stored in the DNS metadata records includes, for example, priority information received in response to a DNS query request for MX records or metadata relating to the network communication that contains the domain identifier.

Each DNS metadata record can further include additional information that is gathered from sources other than the DNS traffic or the network communication. For example, DNS metadata records can includes Autonomous System Numbers (ASNs) which are associated with particular domains corresponding to the record identifiers. As will be discussed further below, ASNs can be collected from remote network sources by the intelligent DNS monitoring system and used to augment the DNS metadata records by linking the ASNs with particular domains (and records identifiers).

Table 200 is provided only as an example of a table in the DNS information database 106 and the fields and columns shown therein are not intended to be limiting. The DNS database can store, track, and/or aggregate any data or metadata relating to monitored DNS traffic or detected network communications, or gathered from additional domain information data sources on the network.

Returning to FIG. 1, the cyberattack detector 104 is also configured to receive at least a portion of the updated DNS metadata record from the DNS information database 106 via database controller 105. This received portion includes one or more occurrence metrics stored in the DNS metadata record and can also include other fields from the DNS metadata record pertaining to historical DNS traffic and/or domain metadata.

The receipt of the portion of the updated DNS metadata record can be in response to the update request sent by cyberattack detector 104. For example, the update request can include a request to return a portion or all of the information stored in the DNS metadata record being updated.

The receipt of the portion of the updated DNS metadata record can alternatively be in response to a separate query request sent from the cyberattack detector 104 to the DNS information database 106 (via database controller 105) after the update request. In this case, the query request can use the same record identifier previously generated for the update request to query the DNS information database for some or all of the fields in a particular DNS metadata record.

Optionally, the information requested and received by the cyberattack detector 104 from the DNS information database 106 can be based upon risk assessment rules 104B. In particular the risk detection rules 104B can specify the fields required to make cybersecurity risk assessments and the cyberattack detector 104 can request the information in these fields for the corresponding DNS metadata record from DNS information database 106.

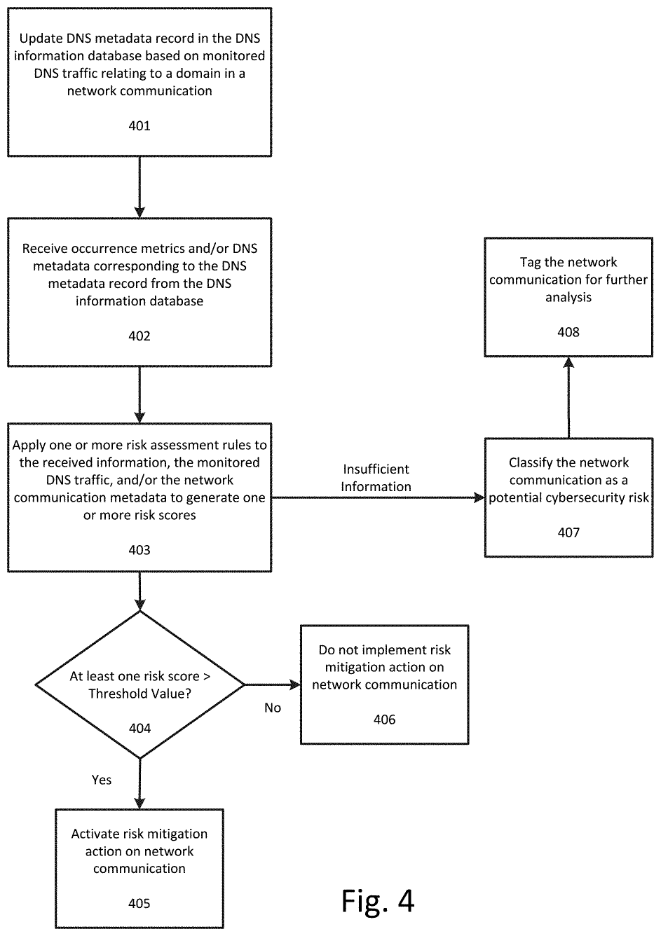

The risk detection logic 104A is configured to apply the risk assessment rules 104B to the information received from the DNS information database 106 to make an assessment regarding cybersecurity risk. This process is described in greater detail with respect to FIG. 4 but generally includes the application of the risk assessment rules to one or more occurrence metrics retrieved from the corresponding DNS metadata record to determine whether the one or more occurrence metrics are indicative of a cybersecurity risk. More specifically, the risk detection logic 104A applies risk assessment rules 104B to one or more occurrence metrics retrieved from the corresponding DNS metadata record to determine one or more risk scores and determines whether the one or more risk scores exceed certain predefined risk thresholds. The thresholds used for assessing cybersecurity risk, as well as the risk assessment rules 104B, are user configurable, such as by a system administrator.

As explained in greater detail with reference to FIG. 4, the risk detection logic 104A can optionally also apply the risk assessment rules (or a portion of the risk assessment rules) to other information retrieved from the corresponding DNS metadata record to determine risk scores. This other information includes metadata relating to previous DNS traffic, metadata relating to currently detected DNS traffic, and/or metadata relating to the detected network communication.

The other information stored in the DNS metadata record that is retrieved by the cyberattack detector 104 can also include metadata relating to a corresponding domain that is gathered from domain information data sources 123 by a domain information data miner 108 that mines the domain information data sources 123 on the computer network 120 via interface 101. The domain information data miner 108 is configured to collect information pertaining to domains stored in records of the DNS information database from the domain information data sources 123 via interface 101. The domain information data sources 123 can include, for example, computing devices or databases of proprietary sources or third party sources made available commercially or otherwise to provide registration information on Internet resources, such as the Réseaux IP Européens Network Coordination Centre (RIPE NCC), which publishes information on ASNs. The domain information data miner 108 then analyzes, aggregates, or otherwise processes the collected information and updates any DNS metadata records in the DNS information database 106 that pertain to the collected information. This additional information stored in the records of the DNS information database 106 can then be used in the risk assessment process by the cyberattack detector 104.

Cyberattack detector 104 provides the results of the risk assessment analysis to mitigation controller 107, which includes mitigation logic 107A that is configured to determine whether to activate any mitigation actions 107B based upon the results, determine which mitigation actions 107B to activate, and implement the selected mitigation actions 107B. Results that are passed to the mitigation controller can include, for example, an indication of all risk assessment rules for which the risk score exceeds a corresponding threshold and/or an indication of the degree to which a risk score exceeds a corresponding threshold, or an aggregate score computed by statistically combining or selecting individual scores resulting from the application of risk assessment rules (such as, for example, the highest score, average score, etc.)

The mitigation actions 107B that are selected for activation can optionally be linked to specific risk assessment rules, such that a risk score greater than a predefined threshold resulting from the application of a specific risk assessment rule results in performance of a corresponding risk mitigation action. The selected mitigation actions 107B can also be determined based on a degree to which a risk score is greater than a predefined threshold. For example, a risk score that greatly exceeds a threshold may trigger a stronger mitigation action than a risk score that only slightly exceeds the threshold.

Selection of mitigation actions can further be determined based upon multiple risk scores and risk thresholds associated with multiple risk assessment rules. For example, certain mitigation actions can be activated only if two distinct risk scores exceed their corresponding risk thresholds whereas other mitigation actions can be activated if only a single risk score exceeds a corresponding risk threshold.

Mitigation actions 107B can include, for example, rejecting the network communication, quarantining the network communication, removing a URL within the network communication, and/or modifying a URL within the network communication. For example, a malicious URL within an email can be replaced with an email that directs the end-user to a soft-landing page that alerts the user of the cybersecurity attack and provides guidance on how to avoid such attacks in the future. At the same time, or instead, as another mitigation action (by the administrator via a remote portal) a network administrator can be sent an alert informing them of the cybersecurity attack attempt and providing information of the user that clicked the malicious link. The administrator alert can be sent, for example, by email or text, provided as a deployed screen of a management console, or accessed via a remote portal.

After determining an appropriate mitigation action, the mitigation controller 107 is configured to send instructions to interface 101 to implement the determined mitigation action either automatically or commanded by the administrator entered e.g., through a management interface. Interface 101 receives the instructions and implements the mitigation. For example, if the mitigation action is rejection of an SMTP communication, then the interface 101 can respond to the network communication with a connection refused response to the SMTP communication.

The components of system 100 shown in FIG. 1 illustrate one possible configuration of a system for mitigating cybersecurity risk by analyzing domain name system (DNS) traffic. Other configurations can also be utilized. In an alternative embodiment, the DNS resolver 103 is not located within the intelligent DNS monitoring system 100 but rather within a remote device or service accessed over the computer network 120. In this case, the monitored DNS traffic between the DNS resolver 103 and the name servers 122 can be detected by the interface 101 and passed directly to the cyberattack detector 104, which can be configured to use domain identifier information in the monitored DNS traffic to match the DNS traffic to domain identifiers extracted from detected network communications by the domain extractor 102 and passed directly to the cyberattack detector 104 from domain extractor 102.

FIG. 3 illustrates a message flow diagram between components of the system for mitigating cybersecurity risk by analyzing domain name system (DNS) traffic according to an exemplary embodiment. As with other message flow diagrams, the chronological order of messages is reflected in descending order from the top of the diagram to the bottom of the diagram. Additionally, communications between adjacent components in the message flow diagram are indicated with solid arrows, whereas communications between non-adjacent components are indicated with dashed arrows.

As shown in FIG. 3, the interface 101 detects a network communication on a computer network and passed the network communication to the domain extractor 102. Domain extractor 102 then extracts a domain identifier from the network communication and passes the domain identifier to DNS resolver 103. The DNS resolver 103 then generates and transmits DNS queries back to interface 101, which forwards them to the relevant name servers (not shown), receives responses, and forwards the DNS responses back to DNS resolver 103.

Next, the monitored DNS traffic, which includes the DNS queries and the DNS responses is sent from DNS resolver 103 to cyberattack detector 104. As discussed earlier, the cyberattack detector 104 extracts information from this monitored DNS traffic to generate a record identifier. The record identifier can optionally be generated solely from the domain identifier, such as by performing some transformation or hashing of the domain identifier. The record identifier can also be based on a combination of a domain identifier and a DNS record type or based on a combination of a domain identifier, DNS record type, and DNS response value contained within a DNS response in the monitored DNS traffic.

When generating the record identifier, the domain identifier and optionally the requested record type and/or the DNS response value can be combined to generate a combined value. This combination can be performed in a variety of ways. For example, the string values of each of the domain identifier, the requested record type, and the DNS response value can be concatenated or otherwise merged to produce a single combined value using a hash function which can be applied to the individual components prior to their combination or in a single combined value to generate the record identifier.

After generating the record identifier, the cyberattack detector 104 transmits a record update to the database controller 105 that is then passed from the database controller 105 to the DNS information database 106. As discussed previously, the record update includes information that is based on the monitored DNS traffic and is configured to update a DNS metadata record corresponding to the generated record identifier within the DNS information database 106. The record update additionally specifies information to be returned from the DNS information database 106 in response to the update. For example, the record update can specify an update of one or more occurrence metrics in a DNS metadata record and can further specify that the updated one or more occurrence metrics (and/or other fields within the DNS metadata record) should be returned in response to the DNS information database 106 receiving the update. The record update therefore includes a query component (such as an SQL SELECT command) in addition to an update component.

The record update is then transmitted to the DNS information database 106 by database controller 105, where the information included in the record update is used to update the relevant DNS metadata record indicated by the update. The query component of the update is then applied to the DNS information database 106 to select and return the requested information (such as occurrence metrics) from the DNS information database 106 to the database controller 105 and then the cyberattack detector 104.

Note that while the message flow diagram of FIG. 3 illustrates occurrence metrics being returned from the DNS information database 106, the returned information can additionally include any of the other types of domain related information stored in the DNS information database previously discussed, such as metadata associated with the domain identifier and/or metadata relating to previous DNS traffic other than occurrence metrics.

The cyberattack detector 104 then conducts a risk assessment to determine a level of risk associated with the network communication. As discussed in greater detail with respect to FIGS. 1 and 4, the risk assessment involves the application of one or more risk assessment rules to the returned occurrence metrics, metadata associated with the domain identifier, metadata relating to previous DNS traffic, metadata relating to currently detected DNS traffic, and/or metadata relating to the detected network communication.

The risk assessment results are then passed from the cyberattack detector 104 to the mitigation controller 107. As discussed with respect to FIG. 1, the mitigation controller 107 identifies appropriate mitigation actions based upon the risk assessment results and then sends commands to implement these mitigation actions to the interface 101, for example, in an alert.

FIG. 4 illustrates a flowchart showing the steps performed by the cyberattack detector and mitigation controller to mitigate cybersecurity risk by analyzing domain name system (DNS) traffic according to an exemplary embodiment.

At step 401 a DNS metadata record in the DNS information database is updated based on monitored DNS traffic relating to a domain in a network communication. As discussed earlier, this step involves the cyberattack detector transmitting the update, via the database controller, to the DNS information database.

At step 402 occurrence metrics and/or DNS metadata corresponding to the DNS metadata record are received from the DNS information database. Once again, this information is passed from the DNS information database to the cyberattack detector via the database controller.

At step 403 one or more risk assessment rules are applied to the received information, the monitored DNS traffic, and/or the network communication metadata to generate one or more risk scores. This step is performed by the cyberattack detector and involves the application of one or more risk assessment rules to the occurrence metrics returned from the DNS information database, DNS metadata returned from the DNS information database, monitored DNS traffic, and/or network communication metadata.

A variety of different risk assessment rules can be used assess cybersecurity risk. For example, a risk assessment rule can compare a first occurrence metric of a date of registration of a particular domain with a second occurrence metric of an activity level pertaining to that domain over a preceding time period (such as the past 6 months) to generate a risk score. This prevents the scenario where a spammer registers a domain and then waits for a period of time before using it to provide the illusion of legitimacy. The risk assessment rule can calculate a score based upon the date of registration and activity and compare that score to a threshold value (such as minimum score) to determine whether to trigger a risk mitigation action.

Another risk assessment rule can determine the occurrence count or occurrence rate of a particular domain associated with a DNS metadata record relative to a minimum occurrence threshold. For example, if a network communication includes a domain identifier that has never been observed before, then the update request will insert a new DNS metadata record into the DNS information database associated with that domain identifier. However, the occurrence count associated with the new record will be 1. The risk assessment rule can require that the occurrence count meet some minimum value (e.g., 100). In this case, the risk assessment rule can assign a risk score based on the occurrence count and the minimum required occurrence count. For example, the risk assessment rule can determine the risk score as (Actual Occurrence Count)/(Minimum Required Occurrence Account)= 1/100=0.01. The threshold value for this risk assessment rule can be set to “1” meaning that risk scores less than 1 are flagged as corresponding to a cybersecurity risk. In this example, since the risk score is 0.01 and the threshold is 1, all new domain identifiers will be flagged as corresponding to a cybersecurity risk. The occurrence count and the minimum required occurrence count can be received as part of step 402. In particular, the DNS information database can store counters that track various metrics used in the risk assessment rules and provide those metrics to the cyberattack detector in step 402.

It is desirable to identify and flag newly observed domains as potential cybersecurity risks due to the use of new domains by cyber attackers. Since new domains frequently have little aggregate metadata and have not been flagged by existing systems (e.g., in blacklists), they are frequently used to launch cyberattacks on systems that are not specifically filtering for them. By identifying newly observed domains through the above-described techniques, the present system enables detection of cyberattacks even when a domain has not previously been flagged as suspicious.

In another example, a risk assessment rule can examine the occurrence metric of TTL values of mail servers associated with a particular domain to determine whether they conform to expected values (such as average or expected values for other mail servers in the relevant time period). The risk assessment rule can calculate a score measuring, for example, the deviation of a TTL value from an expected TTL value. The score can then be compared to a threshold value to determine whether to trigger a risk mitigation action. A score that indicates a large deviation between a TTL value and an expected TTL value can indicate a malicious actor. For example, a malicious actor can spoof a particular domain and provide DNS response values to DNS queries that are designed to bypass or breach security protection. By comparing a TTL value with an expected TTL value (based on previous responses associated with that domain), this spoofing can be detected and avoided.

Risk assessment rules can also analyze information received from the DNS information database in conjunction with the monitored DNS traffic and/or metadata pertaining to the network communication. For example, risk assessment rules can compare the monitored DNS traffic information (such as DNS responses received from name servers in response to DNS queries or DNS queries) with historical DNS traffic information stored in the DNS information database and determine a score based upon discrepancies between the two. The score can then be compared to a threshold value to determine whether to trigger a risk mitigation action.

The application of the risk assessment rules in step 403 results in the generation of one or more risk scores. At step 404 a determination is made regarding whether at least one of the one or more risk scores is greater than a corresponding cybersecurity risk threshold. Each cybersecurity risk threshold can be set based upon the corresponding risk assessment rule and can be configured by a user, such as a system administrator. Step 404 can be performed either by the cyberattack detector or the mitigation controller. For example, the cyberattack detector can send risk scores to the mitigation controller, which can store the corresponding cybersecurity risk thresholds and make the determination indicated in step 404. Alternatively, the cyberattack detector can store the corresponding cybersecurity risk thresholds for each risk assessment rule and make the determination indicated in step 404 itself.

If at least one risk score exceeds a corresponding cybersecurity risk threshold, then at step 405 a risk mitigation action is activated on the network communication. Otherwise, at step 406, no risk mitigation action is implemented on the network communication. Steps 405 and 406 can be performed by the mitigation controller, as discussed previously with respect to FIG. 1.

There can be scenarios where there is insufficient information to determine whether a cybersecurity risk exists. For example, the data required to determine a risk score in step 403 may not be available in the DNS metadata record or in some other required field or the sample size of aggregate information may be too small. In this case, the cyberattack detector can classify the network communication as a potential cybersecurity risk as shown at step 407. At step 408 the network communication is then tagged for further analysis.

This tagging can then be interpreted by email client or other program and used to route the network communication to a queue or other location for further analysis. For example, a network communication can be transmitted to an isolated environment and a linked URL within the email (containing a domain identifier) can be activated to determine whether it results in any malicious scripts or other malware, in which case mitigation instructions can be sent to the mitigation controller. The isolated environment can be used to conduct instrumented and dynamic analysis on the contents of the network communication. For example, a hyperlink in the network communication can be activated and the effect of opening the hyperlink on the isolated system and components of the isolated can be monitored and analyzed dynamically. This can include monitoring background processes, memory usage, CPU load, and other indicators of a cybersecurity attack.

The DNS traffic information and the risk assessment scores generated by the system can also be utilized for intelligence feeds. Specifically, the compiled DNS metadata records, including occurrence metrics, and the risk assessment scores calculated on the basis of the compiled DNS metadata records can be exported to other systems for use in the assessment of domains and cybersecurity operations.

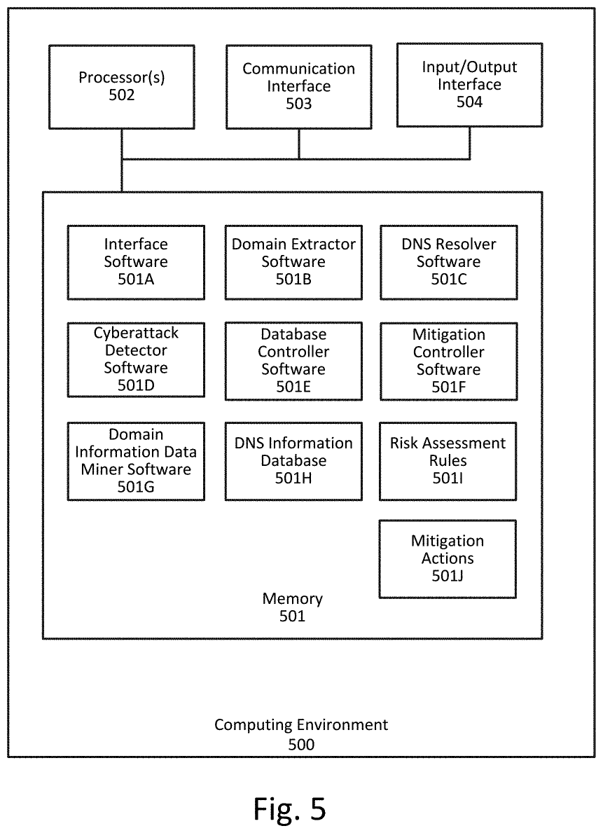

FIG. 5 illustrates computing environment for mitigating cybersecurity risk by analyzing domain name system (DNS) traffic according to an exemplary embodiment. Computing environment 500 includes a memory 501 that is a non-transitory computer-readable medium and can be volatile memory (e.g., registers, cache, RAM), non-volatile memory (e.g., ROM, EEPROM, flash memory, etc.), or some combination of the two.

As shown in FIG. 5, memory 501 stores the interface software 501A, domain extractor software 501B, DNS resolver software 501C, cyberattack detector software 501D (which includes risk detection logic), database controller software 501E, mitigation controller software 501F (which includes the mitigation logic), domain information data miner software 501G, DNS information database 501H, risk assessment rules 501I, and mitigation actions 501J. In the embodiment where the DNS resolver is outside of the system, e.g., device 100, the DNS resolver software 501C can be excluded from memory. All of the software stored within memory 501 can be stored as a computer-readable instructions, that when executed by one or more processors, cause the processors to perform the functionality described with respect to FIGS. 1-4.

Computing environment 500 further includes one or more processors 502. The processors execute computer-executable instructions and can be a real or virtual processors. In a multi-processing system, multiple processors or multicore processors can be used to execute computer-executable instructions to increase processing power and/or to execute certain software in parallel. For example, domain extractor software 501B and interface software 501A can execute in parallel on different processors or processing cores.

The computing environment additionally includes a communication interface 503, such as a network interface, which is used to monitor network communications, communicate with devices on a computer network, collect data from devices on the network, and implement mitigation actions on network communications within the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Computing environment 500 further includes input and output interfaces 504 that allow users (such as system administrators) to provide input to the system and display or otherwise transmit information for display to users. For example, system administrators can utilize the input/output interface 504 to configure risk assessment rules, set cybersecurity risk thresholds, and/or configure mitigation actions. The current settings can also be displayed to users via the input/output interface 504. The display can include a graphical user interface (GUI) that presents options to users such as system administrators for configuring risk assessment rules, set cybersecurity risk thresholds, and mitigation actions. The GUI can also be configured to display alerts that are transmitted as a result of mitigation actions being transmitted.

An interconnection mechanism (shown as a solid line in FIG. 5), such as a bus, controller, or network interconnects the components of the computing environment 500.

Input and output interfaces 504 can be coupled to input and output devices. The input device(s) can be a touch input device such as a keyboard, mouse, pen, trackball, touch screen, or game controller, a voice input device, a scanning device, a digital camera, remote control, or another device that provides input to the computing environment. The output device(s) can be a display, television, monitor, printer, speaker, or another device that provides output from the computing environment 500.

The computing environment 500 can additionally utilize a removable or non-removable storage, such as magnetic disks, magnetic tapes or cassettes, CD-ROMs, CD-RWs, DVDs, USB drives, or any other medium which can be used to store information and which can be accessed within the computing environment 500.

The computing environment 500 can be a set-top box, personal computer, a client device, or one or more servers, for example a farm of networked servers, a clustered server environment, or a cloud network of computing devices

Having described and illustrated the principles of our invention with reference to the described embodiment, it will be recognized that the described embodiment can be modified in arrangement and detail without departing from such principles. Elements of the described embodiment shown in software can be implemented in hardware and vice versa.

In view of the many possible embodiments to which the principles of our invention can be applied, we claim as our invention all such embodiments as can come within the scope and spirit of the following claims and equivalents thereto.

We claim:

1. A method executed by one or more computing devices for mitigating cybersecurity risk by analyzing domain name system (DNS) traffic, the method comprising:
detecting a network communication propagated over a computer network, the network communication comprising a domain identifier;
monitoring DNS traffic to and from one or more DNS servers relating to the domain identifier, the DNS traffic including one or more DNS queries and one or more corresponding responses;
extracting information from the monitored DNS traffic to generate a record identifier;
updating a DNS metadata record stored in memory and associated with the record identifier based at least in part on the monitored DNS traffic, the DNS metadata record comprising one or more occurrence metrics associated with instances of the domain identifier in previous DNS traffic;
determining whether the one or more occurrence metrics are indicative of a cybersecurity risk; and
activating one or more mitigation actions based at least in part on a determination that the one or more occurrence metrics are indicative of the cybersecurity risk.

2. The method of claim 1, wherein the one or more occurrence metrics comprise at least one of: a quantity of prior updates to the DNS metadata record or an occurrence rate of updates to the DNS metadata record during a time period, the occurrence rate being determined based on at least one timestamp associated with at least one occurrence of the domain identifier.

3. The method of claim 1, wherein each occurrence metric in the one or more occurrence metrics corresponds to a type of DNS record and wherein each occurrence metric in the one or more occurrence metrics is updated based on DNS traffic associated with the corresponding type of DNS record.

4. The method of claim 1, wherein the one or more occurrence metrics comprise an average time-to-live (TTL) value associated with one or more previous responses received from the one or more DNS servers and relating to the domain identifier.

5. The method of claim 1, wherein extracting information from the monitored DNS traffic to generate a record identifier comprises:
extracting a record type and a DNS response value from the one or more DNS queries and the corresponding one or more responses; and
generating the record identifier based at least in part on the domain identifier, the record type, and the DNS response value.

6. The method of claim 1, wherein updating a DNS metadata record stored in memory and associated with the record identifier based at least in part on the monitored DNS traffic comprises:
transmitting an update to a DNS database storing the DNS metadata record based at least in part on the monitored DNS traffic, the update comprising the record identifier; and
updating the one or more occurrence metrics in the record corresponding to the record identifier in the DNS database based at least in part on the monitored DNS traffic.

7. The method of claim 1, wherein determining whether the one or more occurrence metrics are indicative of a cybersecurity risk comprises:
applying one or more risk assessment rules to at least the one or more occurrence metrics to generate one or more risk scores.

8. The method of claim 7, wherein determining whether the one or more occurrence metrics are indicative of a cybersecurity risk further comprises:
comparing each of the one or more risk scores with one or more associated cybersecurity risk thresholds.

9. The method of claim 7, wherein the one or more risk assessment rules are further applied to at least a portion of the one or more responses to generate the one or more risk scores.

10. The method of claim 7, wherein determining whether the one or more occurrence metrics are indicative of a cybersecurity risk further comprises:
determining that there is insufficient information to generate the one or more risk scores;
classifying the network communication as a potential cybersecurity risk; and
tagging the network communication for further analysis.

11. The method of claim 1, wherein the DNS metadata record further comprises metadata associated with the domain identifier and further comprising:
applying one or more risk assessment rules to the metadata associated with the domain identifier to generate one or more risk scores; and
activating the one or more mitigation actions based at least in part on a determination that the one or more risk scores exceed one or more associated cybersecurity risk thresholds.

12. The method of claim 1, wherein the one or more mitigation actions comprise one or more of: generating an alert and transmitting the generated alert to a security administrator, rejecting the network communication, dropping the network communication, quarantining the network communication, removing a URL within the network communication, or modifying a URL within the network communication.

13. An apparatus for mitigating cybersecurity risk by analyzing domain name system (DNS) traffic, the apparatus comprising:
one or more processors; and
one or more memories operatively coupled to at least one of the one or more processors and having instructions stored thereon that, when executed by at least one of the one or more processors, cause at least one of the one or more processors to:
detect a network communication propagated over a computer network, the network communication comprising a domain identifier;
monitor DNS traffic to and from one or more DNS servers relating to the domain identifier, the DNS traffic including one or more DNS queries and one or more corresponding responses;
extract information from the monitored DNS traffic to generate a record identifier;
update a DNS metadata record stored in memory and associated with the record identifier based at least in part on the monitored DNS traffic, the DNS metadata record comprising one or more occurrence metrics associated with instances of the domain identifier in previous DNS traffic;
determine whether the one or more occurrence metrics are indicative of a cybersecurity risk; and
activate one or more mitigation actions based at least in part on a determination that the one or more occurrence metrics are indicative of the cybersecurity risk.

14. The apparatus of claim 13, wherein the one or more occurrence metrics comprise at least one of: an average time-to-live (TTL) value associated with one or more previous responses received from the one or more DNS servers and relating to the domain identifier, a quantity of prior updates to the DNS metadata record, or an occurrence rate of updates to the DNS metadata record during a time period, the occurrence rate being determined based on at least one timestamp associated with at least one occurrence of the domain identifier.

15. The apparatus of claim 13, wherein the instructions that, when executed by at least one of the one or more processors, cause at least one of the one or more processors to extract information from the monitored DNS traffic to generate a record identifier further cause at least one of the one or more processors to:
extract a record type and a DNS response value from the one or more DNS queries and the corresponding one or more responses; and
generate the record identifier based at least in part on the domain identifier, the record type, and the DNS response value.

16. The apparatus of claim 13, wherein the instructions that, when executed by at least one of the one or more processors, cause at least one of the one or more processors to determine whether the one or more occurrence metrics are indicative of a cybersecurity risk further cause at least one of the one or more processors to:
apply one or more risk assessment rules to at least the one or more occurrence metrics to generate one or more risk scores; and
compare each of the one or more risk scores with one or more associated cybersecurity risk thresholds.

17. At least one non-transitory computer-readable medium storing computer-readable instructions that, when executed by one or more computing devices, cause at least one of the one or more computing devices to:
detect a network communication propagated over a computer network, the network communication comprising a domain identifier;
monitor DNS traffic to and from one or more DNS servers relating to the domain identifier, the DNS traffic including one or more DNS queries and one or more corresponding responses;
extract information from the monitored DNS traffic to generate a record identifier;
update a DNS metadata record stored in memory and associated with the record identifier based at least in part on the monitored DNS traffic, the DNS metadata record comprising one or more occurrence metrics associated with instances of the domain identifier in previous DNS traffic;
determine whether the one or more occurrence metrics are indicative of a cybersecurity risk; and
activate one or more mitigation actions based at least in part on a determination that the one or more occurrence metrics are indicative of the cybersecurity risk.

18. The at least one non-transitory computer-readable medium of claim 17, wherein the one or more occurrence metrics comprise at least one of: an average time-to-live (TTL) value associated with one or more previous responses received from the one or more DNS servers and relating to the domain identifier, a quantity of prior updates to the DNS metadata record, or an occurrence rate of updates to the DNS metadata record during a time period, the occurrence rate being determined based on at least one timestamp associated with at least one occurrence of the domain identifier.

19. The at least one non-transitory computer-readable medium of claim 17, wherein the instructions that, when executed by at least one of the one or more computing devices, cause at least one of the one or more computing devices to extract information from the monitored DNS traffic to generate a record identifier further cause at least one of the one or more computing devices to:
extract a record type and a DNS response value from the one or more DNS queries and the corresponding one or more responses; and
generate the record identifier based at least in part on the domain identifier, the record type, and the DNS response value.

20. The at least one non-transitory computer-readable medium of claim 17, wherein the instructions that, when executed by at least one of the one or more computing devices, cause at least one of the one or more computing devices to determine whether the one or more occurrence metrics are indicative of a cybersecurity risk further cause at least one of the one or more computing devices to:
apply one or more risk assessment rules to at least the one or more occurrence metrics to generate one or more risk scores; and
compare each of the one or more risk scores with one or more associated cybersecurity risk thresholds.
